(19) United States
(12) Patent Application Publication
(10) Pub. No.: US 2022/0050817 A1
(43) Pub. Date: Feb. 17, 2022

(54) ENHANCING SPARSE INDEXES

(71) Applicant: International Business Machines Corporation, Armonk, NY (US)

(72) Inventors: Shuo Li, Beijing (CN); Xiaobo Wang, Beijing (CN); Sheng Yan Sun, Beijing (CN); Peng Hui Jiang, Beijing (CN)

(21) Appl. No.: 16/991,151

(22) Filed: Aug. 12, 2020

(51) Int. Cl. G06F 16/22; G06F 16/21; G06F 16/248; G06F 16/2457

(52) U.S. Cl. CPC G06F 16/2272; G06F 16/24578; G06F 16/248; G06F 16/213

(57) ABSTRACT

A data structure associated with a sparse index is determined to include a plurality of redundant keys with at least one set of duplicate keys. The at least one set of duplicate keys is ranked, according to a set of criteria. According to the ranking, a first set of duplicate keys from the at least one set is selected. In place of the first set, a first guard node is inserted. The first guard node includes a first key value identical to the first set of duplicate keys and is linked to a first set of field nodes representing a first set of field values associated with the first set of duplicate keys.

### BACKGROUND

The present disclosure relates generally to the field of data structures, and more particularly to the enhancement of sparse indexes.

Sparse indexes can be an efficient means for indexing various data structures because they can be accessed directly without accessing the data structure itself, and they can be settled in the address space memory of a relational database service. Sparse indexes take up less space than dense indexes, with the drawback being that a search function typically takes a longer amount of time, as not every item within the target database is represented within the sparse index.

### SUMMARY

Embodiments of the present disclosure include a method, computer program product, and system for enhancing a sparse index.

A data structure associated with a sparse index is determined to include a plurality of redundant keys with at least one set of duplicate keys. The at least one set of duplicate keys is ranked, according to a set of criteria. According to the ranking, a first set of duplicate keys from the at least one set is selected. In place of the first set, a first guard node is inserted. The first guard node includes a first key value identical to the first set of duplicate keys and is linked to a first set of field nodes representing a first set of field values associated with the first set of duplicate keys.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example diagram of various nodes, in accordance with embodiments of the present disclosure.

FIG. 2 illustrates an example enhanced sparse index implementation, in accordance with embodiments of the present disclosure.

FIG. 3 illustrates an example enhanced multilevel sparse index implementation, in accordance with embodiments of the present disclosure.

FIG. 4 illustrates a flowchart of an example method for creating an enhanced sparse index, in accordance with embodiments of the present disclosure.

FIG. 5 illustrates a flowchart of an example method for searching an enhanced sparse index, in accordance with embodiments of the present disclosure.

FIG. 6 depicts a high-level block diagram of an example computer system that may be used in implementing embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of data structures, and more particularly to the enhancement of sparse indexes. While the present disclosure is not necessarily limited to such applications, various aspects of the disclosure may be appreciated through a discussion of various examples using this context.

Performance is useful in database development and testing. Sparse indexes may be used to index a database, or data structure, under certain conditions, such as when the space taken by the index is of particular concern. The tradeoff is, of course, that a search of the database may take a longer amount of time compared to a dense index, as not every item/document within the database is indexed. Additionally, depending on how the information within the database is sorted, duplicate keys may exist among the various items/documents. In such cases, the performance of a traditional sparse index may be negatively impacted, and therefore a dense index (e.g., an index where every item/document within the database is indexed) may be more useful.

Embodiments of the present disclosure contemplate an enhanced sparse index that may, among other things, increase the performance of a sparse index when a plurality of duplicate keys exist. In some embodiments, this may allow for dense index-like performance, but with the reduced memory requirements like a sparse index.

A traditional sparse index may be thought of as a linked list of key pointers where the key pointers each point to various nodes/items within the database, and the nodes of the database may also be thought of as a linked list. For example, if the database is a linked list of nodes with keys 1, 2, 3, 4, 5, 6, 7, 8, 9, 10, the sparse index may be a list of key pointers pointing to the block addresses for keys 2, 7, and 9. Thus, for example, when a user searches for “8,” the sparse index may point the search to begin a walk of the list/database at “7.” However, in cases where duplicate keys exist (e.g., a linked list of nodes with keys 1, 2, 3, 3, 3, 3, 3, 3, 4, 5, 6, 6, 7, 8, 9, 10), the performance of sparse index decreases, as a search for “3” can take relatively more time.

Embodiments of the present disclosure contemplate a new type of sparse index structure (e.g., an enhanced sparse index). An enhanced sparse index may implement “guard nodes” to represent entire groups of duplicate keys by keeping the key value and branching to a list/loop of field nodes containing the field parts of the duplicate keys. In embodiments, the guard node may save information about the aggregation/plurality of the branch of field nodes and the list of field nodes may be ordered according to that information.

Using the last example linked list, a guard node may replace the key “3,” such that the linked list now reads: 1, 2, 3 (guard node), 4, 5, 6, 6, 7, 8, 9, 10. The guard node may branch into a list of field nodes containing field parts (e.g., secondary characteristics) of the database entries associated with the key “3.” In this way, the implementation of guard nodes and field node lists/loops may increase the speed at which sparse indexes operate when duplicate keys are in play, thus improving performance and increasing the utility over a traditional sparse index. For example, if a search is performed for a key of “4,” a traditional sparse index would cause, in this example, a total number of 8 block accesses (traverse the list of keys 2, 3, 3, 3, 3, 3, 3, 4). However, an enhanced sparse index would only cause a total number of 3 block accesses (traverse the list of keys 2, 3 (guard node), 4).

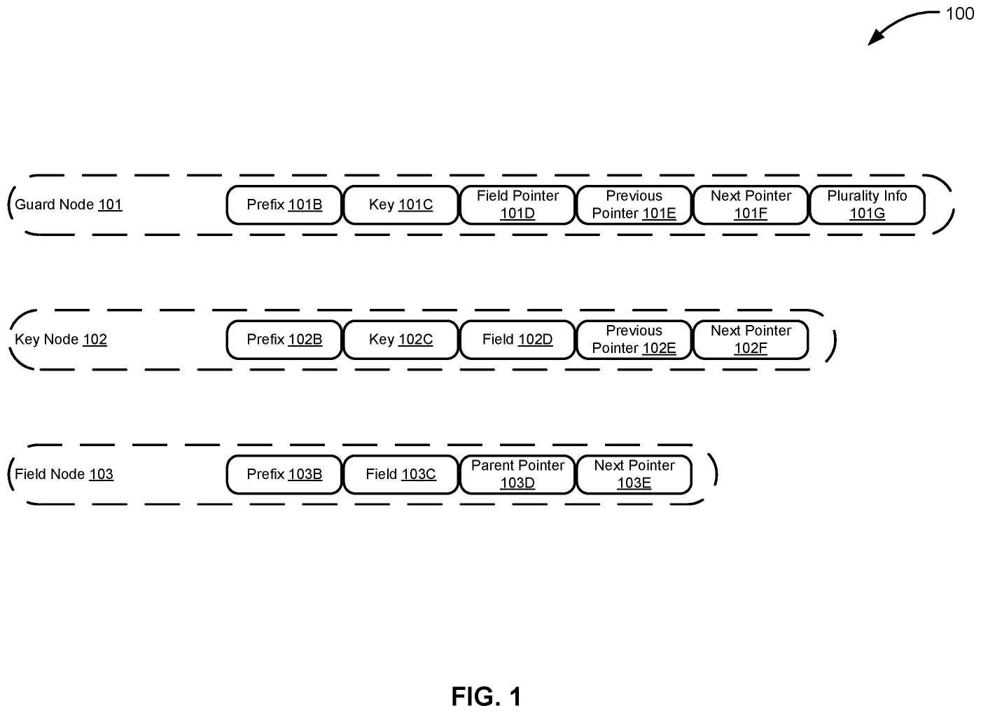

Turning now to FIG. 1, illustrated is an example diagram 100 of various nodes, in accordance with embodiments of the present disclosure. The structure of a guard node 101, key node 102, and field node 103 is shown. Guard node 101 may include, for example, prefix 101B, key 101C, field pointer 101D, previous pointer 101E, next pointer 101F, and plurality info 101G.

Prefix 101B may include, for example, a block address or other unique identifier for the particular guard node 101. Other nodes/records may, in some embodiments, “point” to the prefix 101B.

Key 101C may include a characteristic or field of the document/database entry which may be included in an index. Key 101C may be selected for inclusion within a sparse index or, in some embodiments, an enhanced sparse index.

Field pointer 101D may include a pointer to a field node, such as field node 103, where the field node(s) include one or more fields (e.g., characteristics/fields of the document/database not used for search), such as field 103C. In some embodiments (e.g., enhanced multilevel sparse index embodiments), field pointer 101D may point to a guard node within a succeeding tier of an implementation of an enhanced sparse index.

Previous pointer 101E may include a pointer to either another guard node (e.g., another guard node 101 with a different value for key 101C) or a key node, such as key node 102. The target node of previous pointer 101E would, in some embodiments, precede the guard node 101 in the order of a linked list.

Next pointer 101F may include a pointer to either another guard node (e.g., another guard node 101 with a different value for key 101C) or a key node, such as key node 102. The target node of next pointer 101E would, in some embodiments, succeed the guard node 101 in the order of a linked list.

Plurality info 101G may include information (e.g., aggregation information and/or a digest of characteristics for the items/documents represented by linked field node(s)) regarding the field node(s) linked to the guard node 101. In some embodiments, the plurality info 101G may be used to determine the order in which the field node(s) descend from guard node 101.

Key node 102 may include, for example, prefix 102B, key 102C, field 102D, previous pointer 101E, and next pointer 101F. Prefix 102B may include, for example, a block address or other unique identifier for the particular key node 102. Other nodes/records may, in some embodiments, “point” to the prefix 102B.

Key 102C may include a characteristic or field of the document/database entry which may be included in an index. Key 102C may be selected for inclusion within a sparse index or, in some embodiments, an enhanced sparse index.

Field 102D may include a include one or more fields (e.g., characteristics/fields of the document/database not indexed for search).

Previous pointer 102E may include a pointer to either a guard node (e.g., guard node 101) or another key node in the list. The target node of previous pointer 102E would, in some embodiments, precede the key node 102 in the order of a linked list.

Next pointer 102F may include a pointer to either a guard node (e.g., guard node 101) or another key node. The target node of next pointer 102E would, in some embodiments, succeed the key node 102 in the order of a linked list.

Field node 103 may include, for example, prefix 103B, field 103C, parent pointer 103D, and next pointer 103E. Prefix 103B may include, for example, a block address or other unique identifier for the particular field node 103. Other nodes/records may, in some embodiments, “point” to the prefix 103B.

Field 103C may include a characteristic or field of the document/database entry. Field 103C may be unique or redundant with fields of other field nodes and/or key nodes. In some embodiments, field 103C may be excluded from a sparse index or, in some embodiments, an enhanced sparse index.

Parent pointer 103E may include a pointer to either a guard node (e.g., guard node 101) or another field node in the linked loop/list descending from a particular guard node. The target node of previous pointer 103E would, in some embodiments, precede the field node 103 in the order of a linked loop/list. In some embodiments, the order of field node(s) descending from a particular guard node may be determined according to one or more fields (e.g., field 103C), or according to plurality info 101G.

Next pointer 103F may include a pointer to either another field node (e.g., substantially similar to field node 103) or, in some embodiments, a loop back to a key node or guard node succeeding the guard node from which the field node 103 ultimately descends. The target node of next pointer 103E would, in some embodiments, succeed the field node 103 in the order of the linked loop/list of field nodes descending from the parent guard node, or, in some embodiments, the key node succeeding the parent guard node.

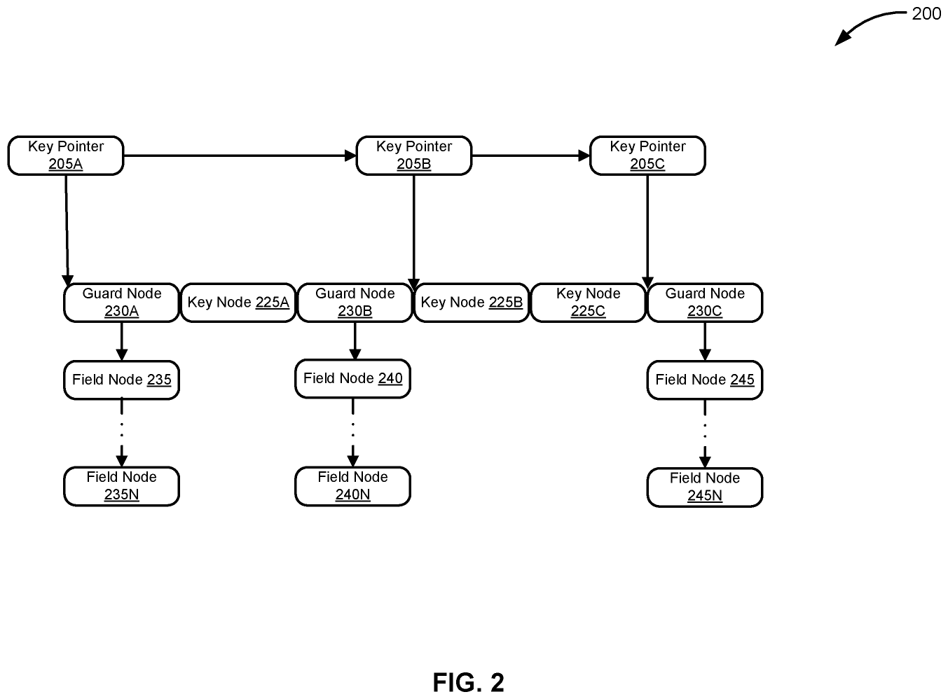

Referring now to FIG. 2, illustrated is an example enhanced sparse index implementation 200, in accordance with embodiments of the present disclosure. Enhanced sparse index implementation 200 may include key pointers 205A-C; guard nodes 230A-C; key nodes 225A-C; and field nodes 235, 235N, 240, 240N, 245, and 245N.

Key pointers 205A-205C may make up a sparse index for a database/data structure comprised of guard nodes 230A-C; key nodes 225A-C; and field nodes 235, 235N, 240, 240N, 245, and 245N. In some embodiments, the sparse index and database/data structure may be simpler or more complex; the depiction here is for illustrative purposes and should not be construed as limiting in any way. Key pointers 205A-C may include, in some embodiments, searchable keys and pointers to particular records/items/documents within a database/data structure.

Guard nodes 230A-C may have a composition substantially similar to guard node 101 and may be part of a linked list of guard nodes and key nodes, as shown. Additionally, guard nodes 230A-C may be parent nodes of linked loops/lists of field nodes, as shown. For example, guard node 230A may be the parent node of field nodes 235-235N, guard node 230B may be the parent node to field nodes 240-240N, and guard node 230C may be the parent node to field node 245-245N. Guard nodes 230A-C may include a key representing a shared characteristic of their respective field node descendants. In some embodiments, the last child node (e.g., field nodes 235N, 240N, and 245N) may loop back to the original linked list. For example, field node 235N may loop back to key node 225A, and field node 240N may loop back to key node 225B.

Key nodes 225A-225C may have a composition substantially similar to key node 102.

Field nodes 235, 235N, 240, 240N, 245, and 245N may have a composition substantially similar to field node 103.

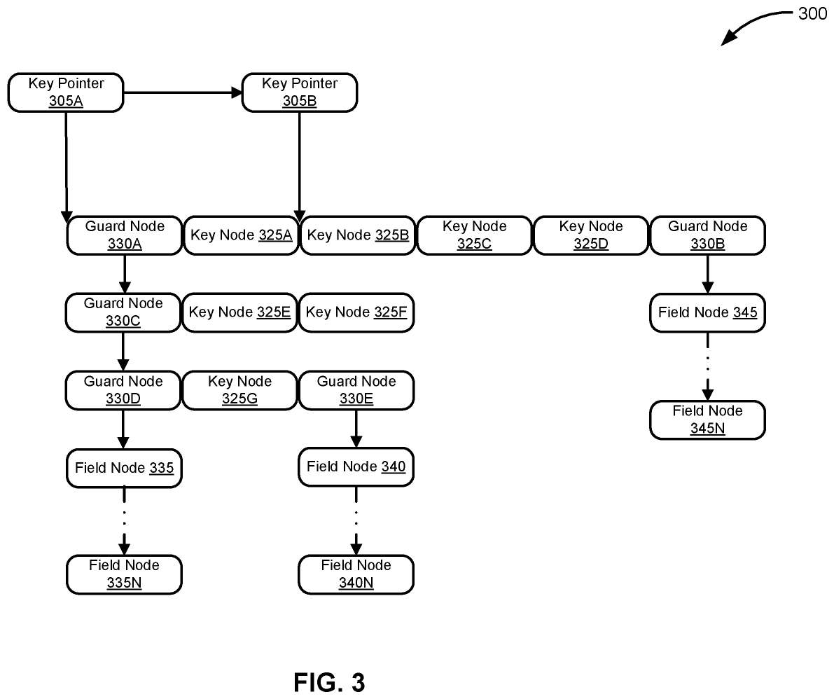

Referring now to FIG. 3, illustrated is an example enhanced multilevel sparse index implementation 300, in accordance with embodiments of the present disclosure. Enhanced multilevel sparse index implementation 300 may include key pointers 305A-B; guard nodes 330A-E; key nodes 325A-G; and field nodes 335, 335N, 340, 340N, 345, and 345N.

Key pointers 305A-305B may make up a first tier of an enhanced sparse index for a database/data structure comprised of guard nodes 330A-E; key nodes 325A-G; and field nodes 335, 335N, 340, 340N, 345, and 345N. In such a multilevel embodiment, however, the index may include multiple tiers/levels, and may overlap with portions of the database/data structure. For example, guard nodes 330A-330B and key nodes 325A-D may be included in a second tier of the sparse index, guard node 330C and key nodes 325E-F may be included in a third tier, and guard nodes 330D-E and key node 325G may be included in a fourth tier, as shown.

In some embodiments, the sparse index and database/data structure may be simpler or more complex; the depiction here is for illustrative purposes and should not be construed as limiting in any way. Key pointers 305A-B may include, in some embodiments, searchable keys and pointers to particular records/items/documents within a database/data structure, as described herein.

Guard nodes 330A-E may have a composition substantially similar to guard node 101 and may be part of various tiers of a linked list of guard nodes and key nodes, as shown. Additionally, guard nodes 330A-E may be parent nodes or intermediate nodes of linked loops/lists of a combination of guard and field nodes, as shown. For example, guard node 330A may be the parent node of guard nodes 330C-D and field nodes 335-335N, guard node 330B may be the parent node to field nodes 345-345N, guard node 330C may be an intermediate node between guard node 330A and guard node 330D (e.g., child node to guard node 330A and parent node to guard node 330D), guard node 330D may be a parent node to field nodes 335-335N, and guard node 330E may be a parent node to field nodes 340-340N.

Guard nodes 330A-E may include a key representing a shared characteristic of their respective guard and/or field node descendants. In some embodiments, the last child node (e.g., field nodes 335N, 340N, and 345N) may loop back to the node succeeding the parent guard node of the loop of field nodes. For example, field node 335N may loop back to key node 325G.

Key nodes 325A-G may have a composition substantially similar to key node 102.

Field nodes 335, 335N, 340, 340N, 345, and 345N may have a composition substantially similar to field node 103.

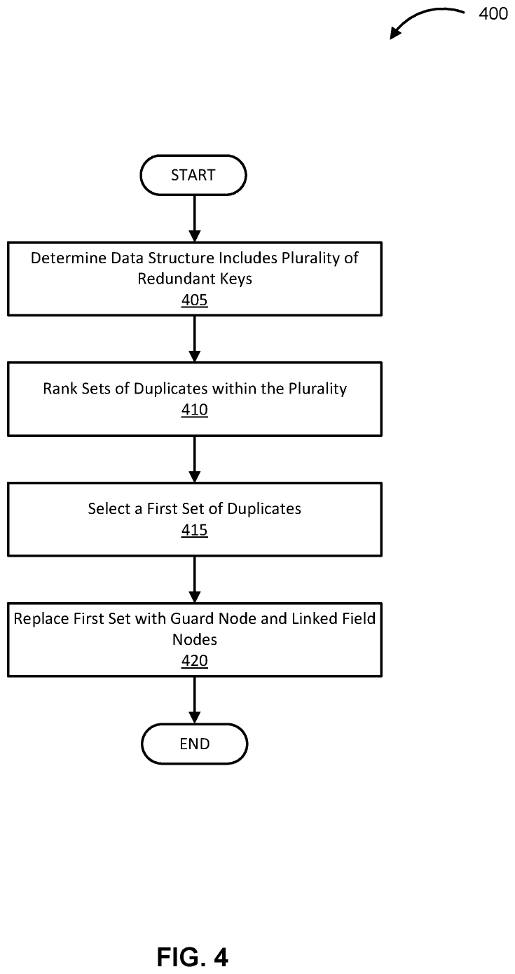

Referring now to FIG. 4, illustrated is a flowchart of an example method 400 for creating an enhanced sparse index, in accordance with embodiments of the present disclosure. Method 400 may begin at 405, where it is determined that a data structure includes a plurality of redundant keys. In some embodiments, it may be beneficial to utilize a data tree structure (e.g., a largest sort tree) of the database records.

In some embodiments, the plurality of redundant keys may include sets of duplicate keys (e.g., one set duplicates where the key=3, a second set of duplicates where the key=8, etc.).

At 410, the sets of duplicate key nodes (e.g., nodes with at least one duplicate key value, but not necessarily duplicate field values) within the plurality are ranked. In some embodiments, the ranking is determined according to the number of duplicate key nodes within each set. For example, the greatest increase in performance may be obtained by replacing the largest number of duplicate key nodes with a guard node and the associated field nodes, as described herein. In some embodiments, the ranking is determined according to a calculation of predicted performance increase. In yet other embodiments, a machine learning model may be trained to predict which set of duplicate key nodes would provide the greatest performance increase, were it to be replaced with a guard node and associated field nodes. In yet other embodiments, the ranking may be performed manually by a user or administrator. In yet other embodiments, the ranking may determine the most-often-accessed sets of duplicate key nodes.

At 415, a first set of duplicates is selected. In some embodiments, this may include the first-ranked set of duplicate key nodes. For example, it may be desirable to process the largest or most-accessed group of duplicate key nodes first. However, in some embodiments, the first set of duplicate key nodes may be the last-ranked set of duplicate key nodes. For example, it may be desirable to make a number of more-quickly processed (e.g., smaller) sets of duplicate key nodes first, in order to more quickly realize smaller performance benefits. In yet other embodiments, a user or administrator may manually select a set of duplicate key nodes, in order to target an area of interest within the database.

At 420, the selected set of duplicate key nodes is replaced with a guard node and a set of linked field nodes representing the replaced duplicate key nodes, as described herein.

In some embodiments, method 400 may continue (not shown) to process each set of duplicate key nodes until no sets of duplicate key nodes remain. In some embodiments, the enhanced sparse index creation process may be achieved using a parallel sysplex to parse and process “chunks” of the database/data structure. This may be beneficial in large databases/data structures where processing the entire database/data structure all at once may cause resource starvation or overflow issues.

In embodiments where a pre-existing enhanced sparse index is altered/updated, key values may be added/deleted/updated and the associated pointers respectively updated. In some embodiments, this may necessitate the creation of a new guard node and/or set of descending field nodes.

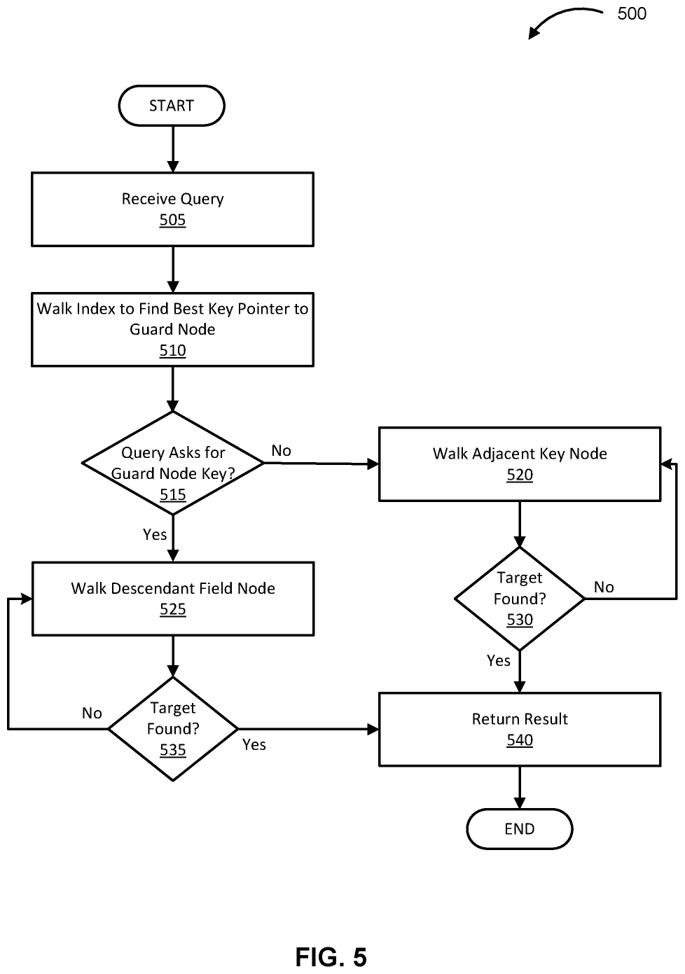

Referring now to FIG. 5, illustrated is a flowchart of an example method 500 for searching an enhanced sparse index, in accordance with embodiments of the present disclosure. Method 500 may begin at 505, where a query is received. The query may include a single key, or it may include more comprehensive search criteria (e.g., a key value and a field value).

At 510, the best key pointer within the index is found. While this example method contemplates the key pointer pointing to a guard node, the key pointer may, in some embodiments, point to a key node, from which the search may ultimately walk to a guard node of interest (e.g., the guard node containing they key which is the subject of the query).

At 515, it is determined whether the guard node contains the key (e.g., key 101C) which is the subject of the query. If yes, the query proceeds to walk down the linked field nodes (using field pointer 101D) descending from the guard node at 525. In some embodiments (e.g., enhanced multilevel sparse indexes), the query may walk down one or more guard nodes, as shown in FIG. 3.

At 535, it is determined whether the descendant field node contains the target (e.g., the key and/or field value(s) associated with the query). If yes, the result is returned at 540 to the source of the query (e.g., a user/administrator/etc.). In some embodiments where multiple field nodes contain the target (which may be determined, in some embodiments, by the key value or the plurality info contained within the guard node), then the set of field nodes fulfilling the target criteria may be returned at 540.

If, at 535, it is determined the descendant field node does not contain the target, the query may continue to walk to the next descendant field node (using next pointer 103E).

If 515 results in “no,” the search walks the adjacent key node at 520 (using next pointer 101F). In some embodiments, the adjacent key node may be another guard node.

At 530, the adjacent node is checked for the key and/or field value(s) associated with the query. If the target (e.g., the key and/or field value(s) associated with the query) is found, the result is returned at 540, as described herein.

If the target is not found at 530, the query may proceed to back to 520 (using next pointer 101F or 102F, depending on node type).

If no node within the database contains the target, the result returned at 540 may indicate that no such record could be found within the database/data structure.

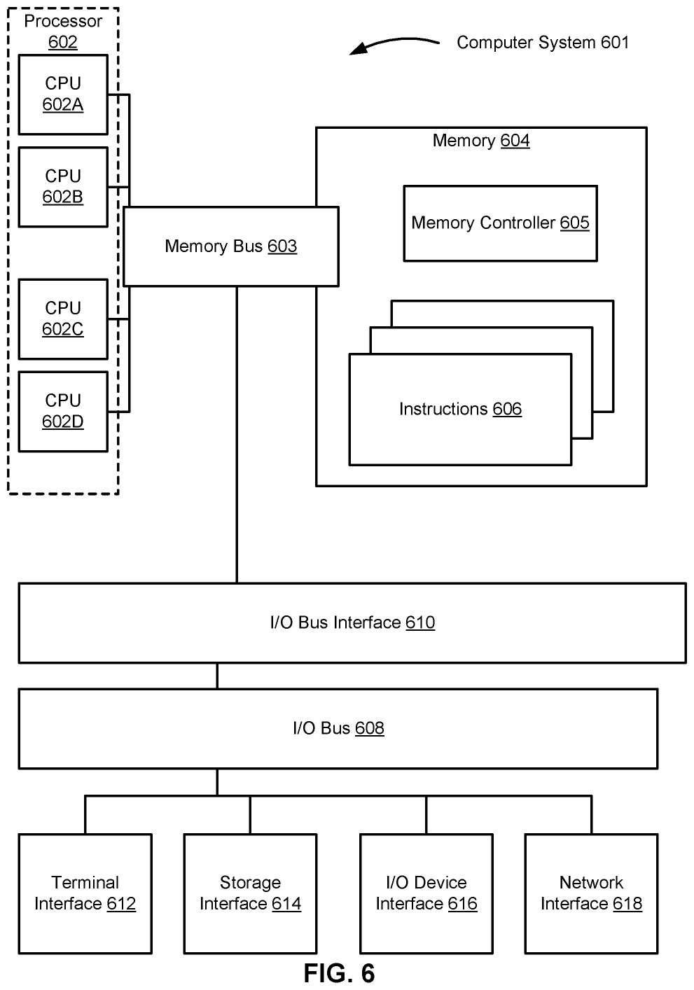

Referring now to FIG. 6, shown is a high-level block diagram of an example computer system 601 that may be configured to perform various aspects of the present disclosure, including, for example, methods 400/500, described in FIGS. 4 and 5. The example computer system 601 may be used in implementing one or more of the methods or modules, and any related functions or operations, described herein (e.g., using one or more processor circuits or computer processors of the computer), in accordance with embodiments of the present disclosure. In some embodiments, the illustrative components of the computer system 601 comprise one or more CPUs 602, a memory subsystem 604, a terminal interface 612, a storage interface 614, an I/O (Input/Output) device interface 616, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may comprise one or more levels of on-board cache. Memory subsystem 604 may include instructions 606 which, when executed by processor 602, cause processor 602 to perform some or all of the functionality described above with respect to FIGS. 4-5.

In some embodiments, the memory subsystem 604 may comprise a random-access semiconductor memory, storage device, or storage medium (either volatile or non-volatile) for storing data and programs. In some embodiments, the memory subsystem 604 may represent the entire virtual memory of the computer system 601 and may also include the virtual memory of other computer systems coupled to the computer system 601 or connected via a network. The memory subsystem 604 may be conceptually a single monolithic entity, but, in some embodiments, the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 604 may contain elements for control and flow of memory used by the CPU 602. This may include a memory controller 605.

Although the memory bus 603 is shown in FIG. 6 as a single bus structure providing a direct communication path among the CPUs 602, the memory subsystem 604, and the I/O bus interface 610, the memory bus 603 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, mobile device, or any other appropriate type of electronic device.

It is noted that FIG. 6 is intended to depict the representative example components of an exemplary computer system 601. In some embodiments, however, individual components may have greater or lesser complexity than as represented in FIG. 6, components other than or in addition to those shown in FIG. 6 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for enhancing a sparse index, the method comprising:
determining a data structure associated with the sparse index includes a plurality of redundant keys, the plurality including at least one set of duplicate keys;
ranking the at least one set of duplicate keys, according to a set of criteria;
selecting, according to the ranking, a first set of duplicate key nodes from within the at least one set; and
inserting, in place of the first set, a first guard node, wherein the first guard node includes a first key value identical to the first set of duplicate key nodes and is linked to a first set of field nodes representing a first set of field values associated with the first set of duplicate key nodes.

2. The method of claim 1, further comprising:
selecting a second set of duplicate key nodes from within the at least one set; and
inserting, in place of the second set, a second guard node, wherein the second guard node includes a second key value identical to the second set of duplicate key nodes and is linked to a second set of field nodes representing a second set of field values associated with the second set of duplicate key nodes.

3. The method of claim 2, wherein the first and second guard nodes include a prefix, a key value, a field pointer, a previous pointer, a next pointer, and a set of plurality information.

4. The method of claim 3, wherein the first and second set of field nodes include a field prefix, a field value, a parent pointer, and a next field pointer.

5. The method of claim 4, wherein the field value of the first and second set of field nodes represents a unique field value from each key node within the first and second set of duplicate key nodes, respectively.

6. The method of claim 5, wherein at least one parent pointer of each of the first and second set of field nodes points to the guard node of the first and second set of guard nodes, respectively.

7. The method of claim 6, wherein the field pointer of the first and second guard nodes points to at least one field node of the first and second set of field nodes, respectively.

8. The method of claim 7, wherein the set of plurality information determines the order in which the first and second set of field nodes descend from the first and second set of guard nodes, respectively.

9. A computer program product for enhancing a sparse index, the computer program product comprising a computer readable storage medium having program instructions embodied therewith, the program instructions executable by a device to cause the device to:
determine a data structure associated with the sparse index includes a plurality of redundant keys, the plurality including at least one set of duplicate keys;
rank the at least one set of duplicate keys, according to a set of criteria;
select, according to the ranking, a first set of duplicate key nodes from within the at least one set; and
insert, in place of the first set, a first guard node, wherein the first guard node includes a first key value identical to the first set of duplicate key nodes and is linked to a first set of field nodes representing a first set of field values associated with the first set of duplicate key nodes.

10. The computer program product of claim 9, wherein the program instructions further cause the device to:
select a second set of duplicate key nodes from within the at least one set; and
insert, in place of the second set, a second guard node, wherein the second guard node includes a second key value identical to the second set of duplicate key nodes and is linked to a second set of field nodes representing a second set of field values associated with the second set of duplicate key nodes.

11. The computer program product of claim 10, wherein the first and second guard nodes include a prefix, a key value, a field pointer, a previous pointer, a next pointer, and a set of plurality information.

12. The computer program product of claim 11, wherein the first and second set of field nodes include a field prefix, a field value, a parent pointer, and a next field pointer.

13. The computer program product of claim 12, wherein the field value of the first and second set of field nodes represents a unique field value from each key node within the first and second set of duplicate key nodes, respectively.

14. The computer program product of claim 13, wherein at least one parent pointer of each of the first and second set of field nodes points to the guard node of the first and second set of guard nodes, respectively.

15. The computer program product of claim 14, wherein the field pointer of the first and second guard nodes points to at least one field node of the first and second set of field nodes, respectively.

16. The computer program product of claim 15, wherein the set of plurality information determines the order in which the first and second set of field nodes descend from the first and second set of guard nodes, respectively.

17-20. (canceled)
